(19) United States
(12) Patent Application Publication
(10) Pub. No.: US 2016/0042389 A1
(43) Pub. Date: Feb. 11, 2016

(54) SYSTEMS, METHODS, AND COMPUTER-READABLE MEDIA FOR CONTEXT-BASED OFFERS

(71) Applicant: Kevin T. Simmons, San Francisco, CA (US)

(72) Inventor: Kevin T. Simmons, San Francisco, CA (US)

(21) Appl. No.: 14/456,433

(22) Filed: Aug. 11, 2014

(51) Int. Cl. G06Q 30/02

(52) U.S. Cl. CPC G06Q 30/0251

(57) ABSTRACT

Systems, methods and computer-readable storage media for generating context-based offers are described. In some embodiments, offer information associated with a preliminary offer for a product may be analyzed to determine a context associated with the preliminary offer. The context may include any property, characteristic, rule, law, regulation, or the like that may affect how the offer may be distributed, redeemed, and/or reimbursed. A context-based offer may be generated and/or distributed based on the context that the preliminary offer is not valid or is regulated in a certain jurisdiction.

### BACKGROUND

Traditional options for providing consumers with promotional offers generally involve physically delivering the offers to consumer homes or retail establishments, such as through newspaper inserts, magazine offers, mailers, coupons, and fliers. However, manufacturers, retailers, and other merchants are increasingly using new forms of technology to exploit new avenues for providing consumers with promotional offers, including discounts, coupons, and free product trials. For example, consumer demand for e-commerce solutions and widespread adoption of mobile and wireless technology have allowed merchants to deliver promotional offers more efficiently and effectively through merchant websites and mobile device applications. The electronic delivery of promotional offers allows merchants to reach a large audience with a relatively low investment. For instance, a manufacturer may provide consumers nationwide with a digital coupon offer using a single website.

Promotional offers for certain products are regulated by federal, state, and/or municipal laws. Illustrative regulated products include alcohol, tobacco, and pharmaceutical products. For example, certain jurisdictions may not allow promotional offers involving alcohol or may require the purchase of an additional item, such as a food product, when purchased with a promotional offer. In another example, certain jurisdictions may limit retailer reimbursement for promotional offers involving tobacco, leading affected retailers to often decline acceptance of such offers. In addition, such laws and regulations change frequently. Accordingly, providing promotional offers for regulated products to a wide audience using Internet and mobile computing technologies is a significant challenge for manufacturers and retailers. As such, merchants often do not promote regulated products using electronic promotional offers due to the difficulty of ensuring compliance with the regulations of each jurisdiction, relying instead on less efficient and less popular traditional distribution methods. Therefore, merchants would benefit from a system that provides an efficient and accurate method for determining the context of a promotional offer that is received by a user, such as the local laws and regulations for a particular product that is the subject of the promotional offer.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a system for generating context-based offers may include a processor, and a non-transitory, computer-readable storage medium in operable communication with the processor. The computer-readable storage medium may contain one or more programming instructions that, when executed, cause the processor to receive a preliminary offer associated with at least one product, access context information associated with the at least one product, determine at least one context for the preliminary offer based on the context information, and generate a context-based offer for the at least one product based on the context. In some embodiments, the system may further include programming instructions that, when executed, cause the processor to receive information associated with an attempted redemption of the context-based offer. In some embodiments, the system may further include programming instructions that, when executed, cause the processor to approve the redemption based on characteristics of the attempted redemption corresponding with the context.

In an embodiment, a computer-implemented method for generating context-based offers may include, by a processor, receiving a preliminary offer associated with at least one product, accessing context information associated with the at least one product, determining at least one context for the preliminary offer based on the context information, and generating a context-based offer for the at least one product based on the context. In some embodiments, the method may further include, by the processor, receiving information associated with an attempted redemption of the context-based offer. In some embodiments, the method may further include, by the processor, approving the redemption based on characteristics of the attempted redemption corresponding with the context.

In an embodiment, a computer-readable storage medium may have computer-readable program code configured to generate a context-based offer embodied therewith. The computer-readable program code may include computer-readable program code configured to receive a preliminary offer associated with at least one product, access context information associated with the at least one product, determine at least one context for the preliminary offer based on the context information, and generate a context-based offer for the at least one product based on the context. In some embodiments, the computer-readable program code may further include computer-readable program code configured to receive information associated with an attempted redemption of the context-based offer. In some embodiments, the computer-readable program code may further include computer-readable program code configured to approve the redemption based on characteristics of the attempted redemption corresponding with the context.

### BRIEF DESCRIPTION OF THE DRAWINGS

The above and other objects of the present invention will become more readily apparent from the following detailed description taken in connection with the accompanying drawings.

FIG. 1 depicts an illustrative context-based offer management system according to some embodiments.

FIG. 2 depicts an illustrative management system according to a some embodiments.

FIG. 3 depicts an illustrative legislative promotion platform management system according to an embodiment.

FIG. 4 depicts a flow for an illustrative method for managing consumer interaction with a context-based offer according to an embodiment.

FIG. 5 depicts a flow diagram of an illustrative method of providing a context-based offer using a retailer loyalty card system according to an embodiment.

FIG. 6 illustrates a block diagram of an illustrative embodiment of a computing device for implementing the various methods and processes described herein.

### DETAILED DESCRIPTION

The described technology generally relates to systems, methods, and computer-readable media for providing context-based promotional offers (“context-based offers”). A promotional offer or offer may include any incentive provided to a consumer to entice the consumer to purchase a product or use a service. Non-limiting examples of offers may include a coupon, a discount, a reward, points, a free trial, a free product, money or “cash back,” free or reduced price merchandise, offers for future free or discounted products or services, offers to purchase other products or services at a discounted rate, or the like. In some embodiments, a context-based offer for a product may include an offer that may be used or “redeemed” according to a context associated with the product, the offer, reimbursement for the offer, and/or an entity associated therewith. In some embodiments, a context-based offer for a product may include an offer associated with various characteristics of the offer and entities associated therewith, such as consumers and/or retailers. A product may include any good or service available for sale, lease, rent, and/or other use by a consumer. Illustrative and non-limiting examples of entities may include a consumer, a retailer, a manufacturer, a distributor, a government entity, a vendor, a consumer package goods company (CPG), or the like. In some embodiments, the context associated with the product, the offer, and/or an entity may include any property, characteristic, rule, law, regulation, or the like that may affect how the offer may be distributed, redeemed, and/or reimbursed.

In some embodiments, an offer and any characteristics associated therewith may be analyzed to determine the context of the offer. For example, the offer may be analyzed to determine whether there are any restrictions, rules, and/or processes for redeeming the offer based on information associated with the offer, the consumer, the entity supplying the offer, the product manufacturer, the entity receiving the offer, or the like at the point-of-sale (POS) to ensure that the offer is managed according to the context. In some embodiments, the context of the offer may be determined at the time of distribution. In such embodiments, the distribution of the offer may be determined based on the context. In some embodiments, the context of the offer may be determined at the time of redemption. In such embodiments, the redemption of the offer may be determined based on the context.

In some embodiments, offers may be associated with various contexts. In some embodiments, an offer may be associated with one context. For example, an offer may be associated with a legal context, such as any legal regulations or laws that may affect the redemption of the offer. In some embodiments, an offer may be associated with a plurality of contexts. For example, an offer may be associated with a legal context and a demographics context that is related to the probability of use of the offer based on consumer demographics information. In this manner, a context-based offer may be generated based on various contexts, such as the legality of the offer and the likelihood of redemption by consumers.

Certain products and offers associated therewith may be restricted or regulated (“regulated products”) by various entities, such as local, state, and federal government bodies, manufacturers, retailers, distributors, vendors, wholesalers, organizations thereof, or the like. Regulated products may include, but are not limited to, alcohol, tobacco and other products containing nicotine, medications, prescription medications, over-the-counter (OTC) medications, marijuana, controlled substances, products containing caffeine, “energy” drinks, products containing sugar, products having a certain caloric content, cleaning products, chemicals, machines, vehicles, firearms, ammunition, financial advice and products, legal advice and services, advertising, manufacturing processes, processes generating pollution, and any other product or process capable of being regulated by an entity.

In some embodiments, an offer associated with a regulated product may be analyzed to determine the context associated therewith, such as the jurisdictions where the product is regulated and any regulations associated therewith. For instance, a distributor of alcoholic beverages may seek to incentivize retailers to sell a particular alcoholic beverage at a discounted rate. The distributor may prepare a digital coupon for download from a web-based platform. However, State A does not allow offers, including coupons, that sell alcoholic beverages at a discounted rate unless certain food products are also purchased during the discounted transaction. The web-based platform may determine that a consumer attempting to download the digital coupon is from State A. Accordingly, the web-based platform may generate a context-based offer (digital coupon) for the consumer from State A specifying that the coupon must be used according to the laws of State A. Accordingly, some embodiments may facilitate convenient, efficient, automated processes for generating and/or distributing offers involving regulated products for consumers to ensure redemption per regional regulations. In addition, some embodiments may be configured to ensure that offers for regulated products are distributed so that they may be successfully redeemed by a consumer and such that entities associated with the distribution and/or redemption of the offer may comply with necessary laws.

Although context-based offers associated with regulated products are described herein, embodiments are not so limited as any type of product and/or context are contemplated according to some embodiments.

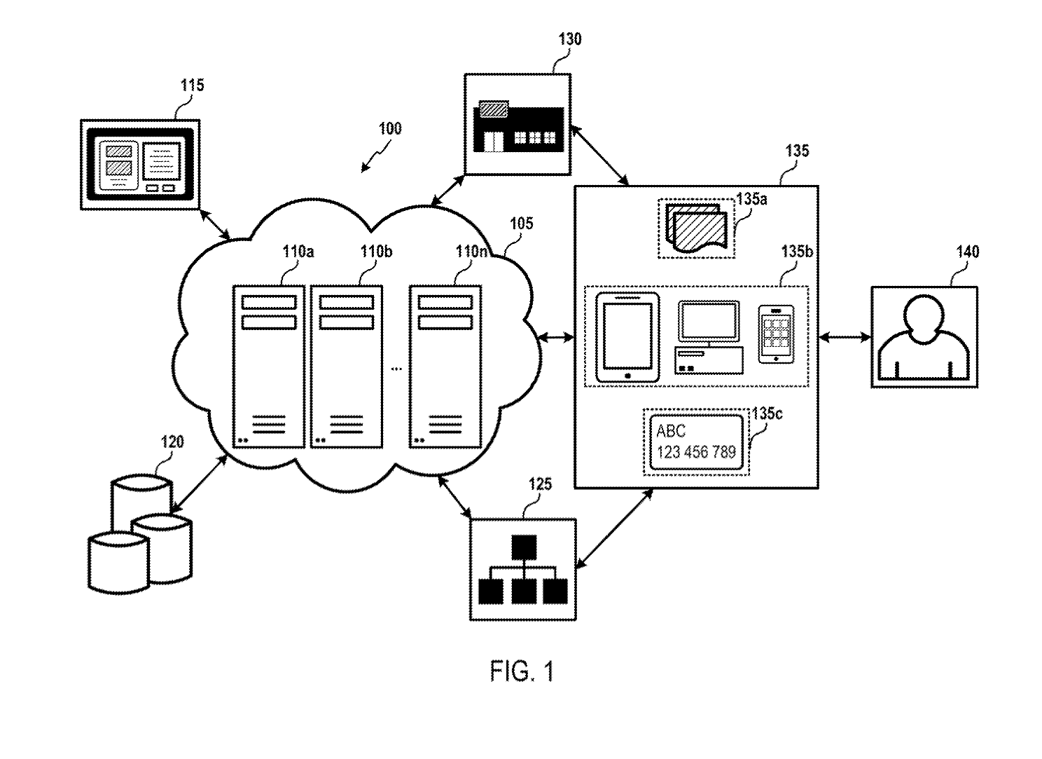

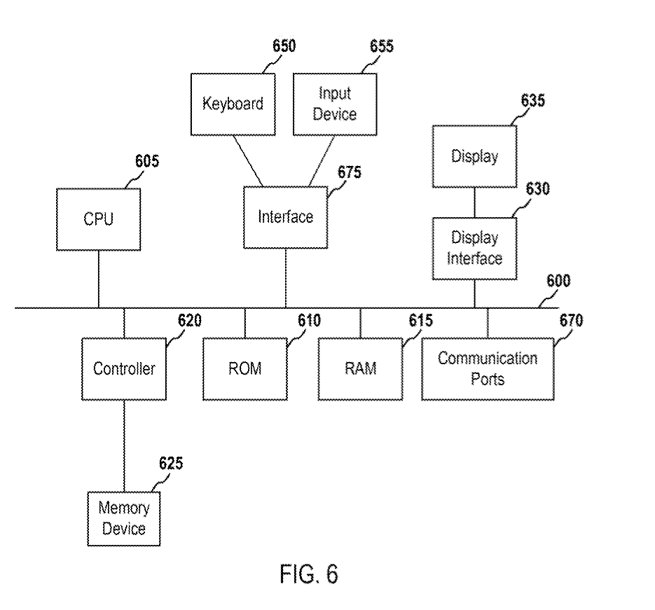

FIG. 1 depicts an illustrative context-based offer management system according to some embodiments. As shown in FIG. 1, the context-based offer management system (the “management system”) 100 may include a network 105 configured as an offer management network (OMN). The network 105 may include one or more server logic devices 110a-n, which may generally include a processor, a non-transitory memory or other storage device for housing programming instructions, data or information regarding one or more applications, and other hardware, including, for example, the central processing unit (CPU) 605, read only memory (ROM) 610, random access memory (RAM) 615, communication ports 640, controller 620, and/or memory device 625 depicted in FIG. 6 and described below in reference thereto. The network 105 may include one or more of a wide-area network (WAN) (such as the Internet), a local area network (LAN), a wireless local area network (WLAN), a mobile wireless network a combination of any of the foregoing, or any other suitable network, and may include any component (physical or logical) necessary for a particular network's functionality, such as routers, adapters, subnets, etc.

In some embodiments, the programming instructions may include a context-based offer application (the “offer application”) configured to, among other things, analyze offers and context information and to generate context-based offers. The server logic devices 110 may be in operable communication with client logic devices associated with various systems 115, 125, 130 and/or consumers 140 through client logic devices 135b. The client logic devices 135b may include, but are not limited to, server computing devices, personal computers (PCs), kiosk computing devices, mobile computing devices, laptop computers, smartphones, personal digital assistants (PDAs), tablet computing devices, point-of-sale devices, electronic retail devices, cash register devices, retail transaction devices, or any other logic and/or computing devices now known or developed in the future.

In some embodiments, the management system 100 and/or components thereof may be configured to determine the legal requirements for distributing an offer in a particular region and/or jurisdiction. The management system 100 may maintain and/or access data regarding the regulations for distributing, redeeming, and using offers for regulated products. As described in further detail below, the management system 100 may be configured to maintain current offer regulation data for regulated product offers for one or more regions and/or jurisdictions. For example, the management system 100 may be configured to include offer regulation data for the United States, Canada, and/or Europe, and/or regions within a country in order to ensure legal distribution of offers to consumers based upon the consumer's location. The management system 100 may accept offers in a manual or automated fashion.

In some embodiments, the offer application may be accessible through various platforms, such as a client application, web-based application, over the Internet, and/or a mobile application (for example, a “mobile app” or “app”). According to some embodiments, the offer application may be configured to operate on each client logic device and/or to operate on a server computing device accessible to logic devices over a network, such as the Internet. All or some of the files, data and/or processes (for example, offer information, context information, consumer information, offer analysis processes, or the like) used for analysis of offers, entities, context information, or the like may be stored locally on each client logic device and/or stored in a central location and accessible over a network.

The management system 100 may include and/or may communicate with various systems, including various entities and/or computing devices and networks associated therewith. An offer supplier 115 may be configured to provide offers to the management system 100. In some embodiments, the offers provided by the offer supplier 115 may not be associated with a context (“preliminary offers”). The offer supplier system 115 may be configured to generate preliminary offers and transmit the offers to the management system 100. The offer supplier 115 may be associated with any entity capable of generating offers, including manufacturers, retailers, distributors, vendors, CPGS, or the like. For example, the offer supplier 115 may be a computer hardware and/or software system managed on behalf of an entity and configured to communicate offers to the management system 100. The offer supplier 115 may communicate offers to the management system 100 using any method known to those having ordinary skill in the art, including mailing physical copies of the offers, email, uploading through a web-based platform or client application, simple messaging system (SMS) messages (“texting”), file transfer protocol (ftp), cloud-based sharing, or the like.

The management system 100 may be in communication with one or more data stores 120. The data stores 120 may include context information, entity information, offer information, consumer information, transaction information, or the like, historical information relating thereto, and/or any type of information that may be used by the management system 100 to analyze offers and/or to generate context-based offers. In some embodiments, the data stores 120 may include third-party information including laws, regulations, guidelines, or other rules associated with a jurisdiction, including, but not limited to, municipalities, towns, cities, villages, boroughs, parishes, counties, states, countries (for instance, the laws of the U.S. federal government, Canada, Mexico, or the like), government agencies (for instance, the U.S. Food and Drug Administration (FDA), the U.S. Department of Commerce, or the like), corporations, and commercial organizations. In some embodiments, the data stores 120 may include third-party information including consumer information databases, product databases, retailer databases, financial databases, and analytics, research, and historical data relating thereto.

In some embodiments, the data store 120 may include offer and/or product regulation data. Offer regulation data may include data regarding laws, regulations, or other rules specific to promotions for regulated or restricted products. Offer regulation data may include information regarding any number of legislative conditions that must be followed in order to distribute and/or redeem an offer for a restricted product in one or more regions. Offer regulation data may, for example, indicate regions where a restricted product offer may include a purchase of a non-restricted product, regions where the offer must include a purchase of a non-restricted product, or regions where the offer does not require a purchase of a non-restricted product. Offer regulation data may also include laws precluding certain entities, such as a CPG, from paying or reimbursing retailers or companies partially or fully owned by retailers for distribution and/or placement of restricted product offers. The following are non-limiting examples of regulated/restricted offers according to certain offer regulations: less than or equal to 5% alcohol by volume without additional purchase requirement; less than or equal to 5% alcohol by volume with additional purchase requirement; greater than 5% alcohol by volume without additional purchase requirement; greater than 5% alcohol by volume with additional purchase requirement; digital sweepstakes; digital games of chance; request for information (RFI) promotions; in-store promotions; mail-in promotions (with or without proof of purchase); and rebate promotions.

The management system 100 may use the information in the data stores 120 to analyze the preliminary offers received from the offer supplier system 115. The management system 100 may analyze the preliminary offers to determine a context associated with the preliminary offers. For example, an offer supplier system 115 may provide a preliminary offer associated with a nicotine-containing product for distribution in the U.S. The management system 100 may analyze the preliminary offer to determine that the context of the preliminary offer is that the preliminary offer is only available to consumers 140 18 years of age and older and that the preliminary offer is void in States A, B, and C. In some embodiments, the management system 100 may generate a context-based offer for consumers 140 that are of 18 years of age and older and who do not live in States A, B, and C. In some embodiments, the management system 100 may generate a context-based offer that includes a description of the regulations or terms of use of the offer visible to a consumer 140 and/or distributor 130 accessing the context-based offer.

In addition, the management system 100 may determine certain demographic information associated with consumers 140 likely to access and/or redeem the context based offer. For instance, the management system 100 may determine that consumers 140 of a particular gender and within a particular age range are most likely to redeem the preliminary offer. In some embodiments, the management system 100 may generate a context-based offer including distribution information regarding consumers 140 likely to redeem the offer. In some embodiments, the management system 100 may selectively distribute the context-based offer to consumers 140 likely to redeem the offer.

The management system 100 may transmit or otherwise make available the context-based offer to various entities. In some embodiments, the management system 100 may be in communication with an offer distributor 125. An offer distributor 125 may generally include a computer hardware and/or software system managed on behalf of an entity and configured to distribute context-based offers generated by the management system 100. Non-limiting examples of offer distributors 125 may include an advertiser, a publisher, a website operator, a mobile application developer, a web-based service provider (for instance, a social networking service provider, a search engine, or the like), a retail service provider (for instance, a loyalty or rewards program service provider), a paper-based coupon or flier provider, or any other entity or service capable of distributing context-based offers. In some embodiments, the management system 100 may send physical context-based offers to offer distributors 125. In some embodiments, the management system 100 or components thereof may communicate with and provide context-based offers directly to consumers 140.

In some embodiments, the management system 100 may be in communication with a retailer 130. In some embodiments, a retailer 130 may be configured as a particular type of offer distributor 125. Non-limiting examples of retailers 130 may include grocery stores, warehouse clubs, gas stations, clothing retailers, electronics retailers, home improvement retailers, beverage retailers, e-commerce website operators, or any type of entity capable of selling goods or providing services to consumers 140. In some embodiments, the retailer 130 may be configured to redeem the context-based offers from consumers 140 according to the context. In some embodiments, the management system 100 may be configured to provide redemption information to the retailer 130 associated with the context of the context-based offer. For example, the management system 100 may provide redemption information instructing a nationwide retailer 130 that the context-based offer is not valid in States A and B. In some embodiments, the retailer 130 may redeem the coupon according to the context.

In some embodiments, the retailer 130 may provide offer transaction information (“transaction information”) associated with the redemption of the context-based offer to the management system 100. For example, the retailer 130 may provide transaction information including price, quantities, geographic information, time information, store information, consumer information, offer medium (for instance, paper-based, digital coupon, or the like), and any other information associated with the transaction. The management system 100 may store the transaction information in the data stores 120 and/or provide the transaction information to associated entities, such as offer suppliers 115, offer distributors 130, and/or other retailers 125.

The context-based offers may be provided to consumers 140 through various offer vehicles 135. Illustrative and non-restrictive examples of offer vehicles may include paper-based offers 135a (for example, coupons, fliers, tear-sheets, rebate forms, or the like), computing devices 135b (for example, applications, mobile applications, web-based platforms, websites, e-commerce sites or the like accessible from a computing device), and retailer cards 135c, such as retailer loyalty, awards, or other program cards known to those having ordinary skill in the art.

Although only one offer supplier 115, offer distributor 125, retailer 130, and consumer 140 are depicted in FIG. 1, some embodiments provide for a plurality of offer suppliers, offer distributors, retailers, and/or consumers. In some embodiments, the offer supplier 115, offer distributor 125, and/or retailer 130 may be a part of the management system 100. For example, the same entity may operate as and/or manage the offer supplier 115, offer distributor 125, retailer 130, and/or the management system 100. For example, a grocery store chain may manage an internal management system 100, operating as the offer supplier 115, offer distributor 125, and/or retailer 130. In another example, a grocery store chain may manage an internal management system 100 and may receive preliminary offers from external offer suppliers 115 (for example, grocery product vendors) and may manage distribution of the context-based offers through its own offer distributors 135 to various regional locations.

In some embodiments, the management system 100 may be configured to provide billing information to offer suppliers 115, offer distributors 125, and/or retailers 130. For example, the management system 100 may be owned or used by an entity providing multiple offer service types and may enable various billing arrangements, including, but not limited to, Cost-per-Download (CPD), Cost-per-Redemption (CPR), and flat rate. In some embodiments, as described in more detail below, the management system 100 may be configured to provide offer clearing/approval services and/or offer tracking and analytics services.

Although the one or more data stores 120 are depicted as being separate from the server logic devices 110a-n, embodiments are not so limited, as all or some of the one or more data stores may be stored in one or more of the server logic devices.

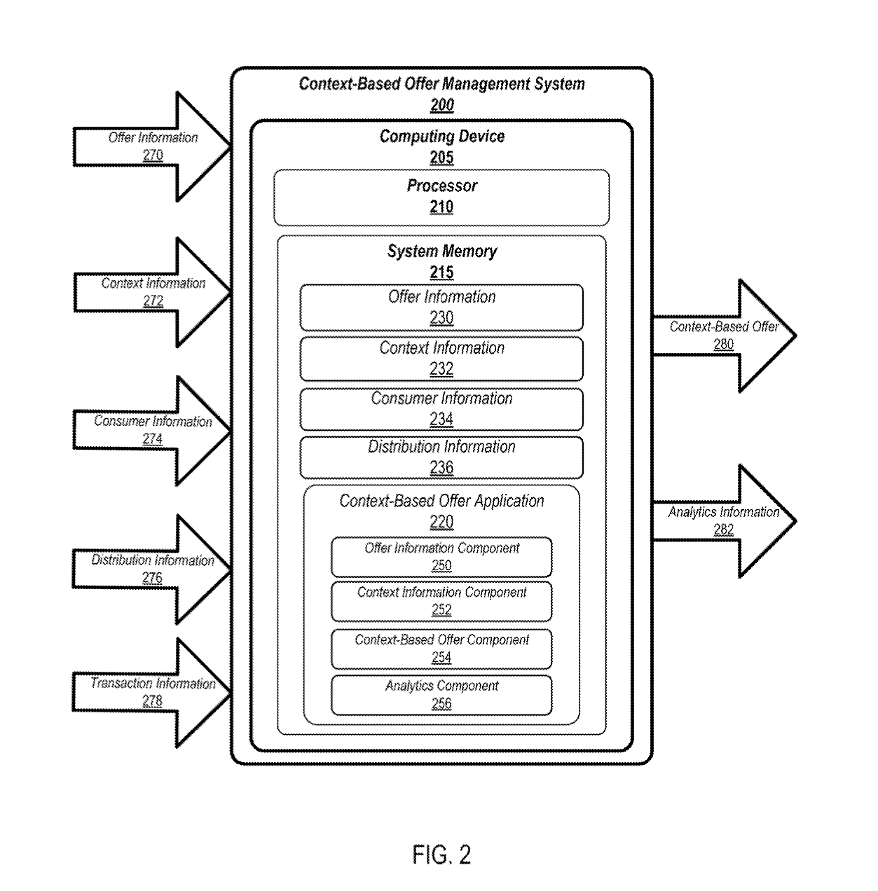

FIG. 2 depicts an illustrative management system according to some embodiments. As shown in FIG. 2, a management system 200 may include a computing device 205 having a processor 210 and system memory 215. The computing device 205 may include any type of computing device, such as the client logic device and server logic devices 110a-n described in reference to FIG. 1. The processor 210 may be configured to execute an offer application 220. The offer application 220 may be configured to receive offer information 270, context information 272, consumer information 274, and/or distribution information 276, for instance, through the processor 210 from the data stores 120 and/or as stored or cached as offer information 230, context information 232, consumer information 234, and/or distribution information 236 in the system memory 215.

The offer information 270 may include any information associated with a preliminary offer received by the management system 200, for instance, from an offer supplier 115. Non-limiting examples of offer information 270 may include a product, a price, a quantity, offer redemption rules, offer restrictions, a retailer, an offer duration (or expiration date), or any other type of information associated with a preliminary offer. For example, offer information 270 for a preliminary offer generated by an offer supplier 115 may specify that the preliminary offer allows a consumer to purchase a particular food product at any participating retailer at a specified discounted price over a particular four-month period, and that the preliminary offer may not be combined with any other offers relating to the particular food product. Offer information 270 relating to a product may include a product name, a universal product code (UPC), product type data, and/or any other type of information associated with a product.

The context information 272 may be used by the offer application 220 to generate a context-based offer 280. The context information 272 may include any type of information that may be related to and/or affect the redemption of a preliminary offer. For example, the offer application 220 may search context information 272 including laws, regulations, and other rules based on the offer information 270 to determine whether the product that is the subject of the offer is a regulated product and, if so, what regulations are associated with the product.

The consumer information 274 may include any information associated with consumers 140 that may receive and/or may redeem a context-based offer 280. For example, the consumer information 274 may include demographic information associated with a consumer, such as name, age, gender, address, income level. In some embodiments, the consumer information 274 may be determined based on a computing device associated with the consumer 140 that is receiving an electronic context-based offer 280, such as location information determined from a global positioning system (GPS) element of the computing device. In some embodiments, the consumer information 274 may include user profile and/or questionnaire information provided by the consumer 140 to an entity, such as through a retailer or manufacturer website or mobile application. For instance, a consumer 140 may set up a user profile with a retailer, such as through a retailer loyalty program as known to those having ordinary skill in the art. The user profile may include consumer information 274 such as demographic information, consumer preferences, and historical purchasing information.

The offer application 220 may use the consumer information 274 to determine whether to distribute a context-based offer to the consumer 140. For instance, if a context-based offer 280 for a medical product may not be redeemed in State A and the consumer information 274 indicates that a consumer 140 lives in State A, the offer application 220 may determine not to send the context-based offer to the consumer and/or to provide a message stating that the offer is not valid in State A.

The offer application 220 may also determine whether a consumer 140 may redeem a context-based offer 280 at the POS based on the consumer information 274 in an embodiment in which a retailer 130 communicates with the management system 200 at the POS (offer “clearing” or “approval” functions). For example, a context-based offer 280 for an alcoholic beverage may not be redeemed in State B. At the point of sale, the retailer 130 may scan or otherwise enter the context-based offer 280 into their transaction system. The transaction system may transmit the transaction and information associated therewith to the management system 200. The offer application 220 may compare the information associated with the transaction with the context information 272 associated with the context-based offer 280 to determine the context-based offer is being redeemed in State B and, as such, may not be redeemed by the retailer. In this manner, a retailer 130 may manage (approve or “clear”) context-based offers 280 using the management system 200 instead of having to use their own internal resources.

The management system 200 may receive transaction information 278 associated with the use of the context-based offers 280 from entities such as offer distributors 125 and retailers 130. For instance, the transaction information 278 may provide data relating to the number of consumers 140 who passively received a context-based offer 280 and/or the method of delivery, such as email, SMS messaging, physical delivery, entity card (for example, automatic download to retailer loyalty card) or the like. The transaction information 278 may include data relating to the number of consumers 140 who actively obtained a context-based offer 280 and/or the method of delivery, such as downloading via a website or application. The transaction information 278 may include data relating to the use or non-use of the context-based offer 280 including information associated with consumers 140 who redeemed a context-based offer or who received a context-based offer but did not redeem. The transaction information 278 redemption data may include, but is not limited to, a price, a quantity, geographic information, time information, store information, consumer information 274, an offer medium (for instance, paper-based, digital coupon, or the like), and any other information associated with the transaction.

The offer application 220 may include various modules, programs, applications, routines, functions, processes, or the like (“components”) to perform functions according to some embodiments described herein. In some embodiments, the offer application 220 may include an offer information component 250, a context information component 252, a context-based offer component 254, and/or an analytics component 256. Although the components 250-256 of the offer application 220 are depicted as separate components in FIG. 2, embodiments are not so limited, as the components and the functionality thereof may be configured within the same component and/or shared among components. The term “component” may refer to a computer-related entity, such as hardware, a combination of hardware and software, software, or software in execution. For example, a component may include, but is not limited to being, a process running on a processor, a processor circuit, a hard disk drive, multiple storage drives, an object, an executable, a thread of execution, a program, and/or a computer.

The offer information component 250 may be configured to receive offer information 270. In some embodiments, the offer information component 250 may be configured to analyze and/or parse the offer information 270 to determine elements of the preliminary offer associated therewith that may be used to determine the context of the preliminary offer (“offer context elements”). For example, the offer application 220 may receive offer information 270 relating to a preliminary offer relating to providing a medical product for a reduced price at a particular retailer. The offer information component 250 may analyze the offer information 270 and determine that the offer context elements of a medical product (for instance, as a general type or class of product), the particular medical product that is the subject of the offer, the retailer, and the type of offer (for instance, a reduced price) may be used to determine the context.

The context information component 252 may use the offer information 270, for instance, the offer context elements to determine the context of the preliminary offer. In some embodiments, the context information component 252 may use the offer context elements to search the data stores 120, including third-party information, to determine the context of the preliminary offer. For example, the context information component 252 may determine that the preliminary offer includes a regulated product and may access the specific regulations associated therewith for each jurisdiction where the preliminary offer may be accessed and/or redeemed. In another example, the context information component 252 may determine that the preliminary offer is weather-related (for instance, sun screen) and may provide regions where the weather is conducive to redemption of the preliminary offer.

The context-based offer component 254 may be configured to generate a context-based offer 280 based on the context of the preliminary offer as determined by the context information component 252 and/or other information associated with the preliminary offer, consumer information 274, and/or distribution information 276. For example, the context of a preliminary offer for an alcoholic beverage may specify that the offer is not valid in State A and may only be used by consumers 140 over the age of 21. In some embodiments, the context-based offer component 254 may generate a context-based offer 280 that includes instructions that the offer may not be used in State A and may only be redeemed by individuals over the age of 21. In some embodiments, the context-based offer component 254 may determine which regions an offer may be distributed to and which requirements must be met to ensure legal distribution and/or redemption of the offer.

In some embodiments, the context-based offer component 254 may receive consumer information 274 relating to a consumer 140 attempting to receive the context-based offer 280, for instance, through a download via a website or mobile application in communication with the management system 200. In some embodiments, the context-based offer component 254 may not allow access to the context-based offer 280 to consumers 140 in particular jurisdictions or who have demographic information that indicates that they may not redeem the context-based offer. In some embodiments, the context-based offer component 254 may provide a notice or warning to a consumer 140 attempting to access a context-based offer 280 stating that the consumer information 274 indicates that they may not be able to redeem the context-based offer. In some embodiments, the context-based offer component 254 may be configured to allow access and/or provide notice to offer distributors 125 based on the distribution information 276 and the context of the context-based offer 280. In some embodiments, the context-based offer component 254 and/or the offer application 220 may communicate the context-based offers 280 and/or information associated therewith (for example, restrictions) generated by the context-based offer component to one or more entities.

The analytics component 256 may be configured to analyze information associated with a context-based offer 280, including, but not limited to, the consumer information 274 and the transaction information 276. The analytics component 256 may be configured to analyze information associated with the context-based offer 280 and to generate analytics information 282 providing, data, statistics, patterns, and any other type of analytics information associated with the distribution and/or use of context-based offers. The management system 200 may provide the analytics information 282 to various entities associated with the context-based offers, including offer suppliers 115, offer distributors 125, and/or retailers 130. In this manner, entities associated with the generation and/or use of the preliminary offers and/or context-based offers 280 may gain insight into consumer 140 access and use of the context-based offers.

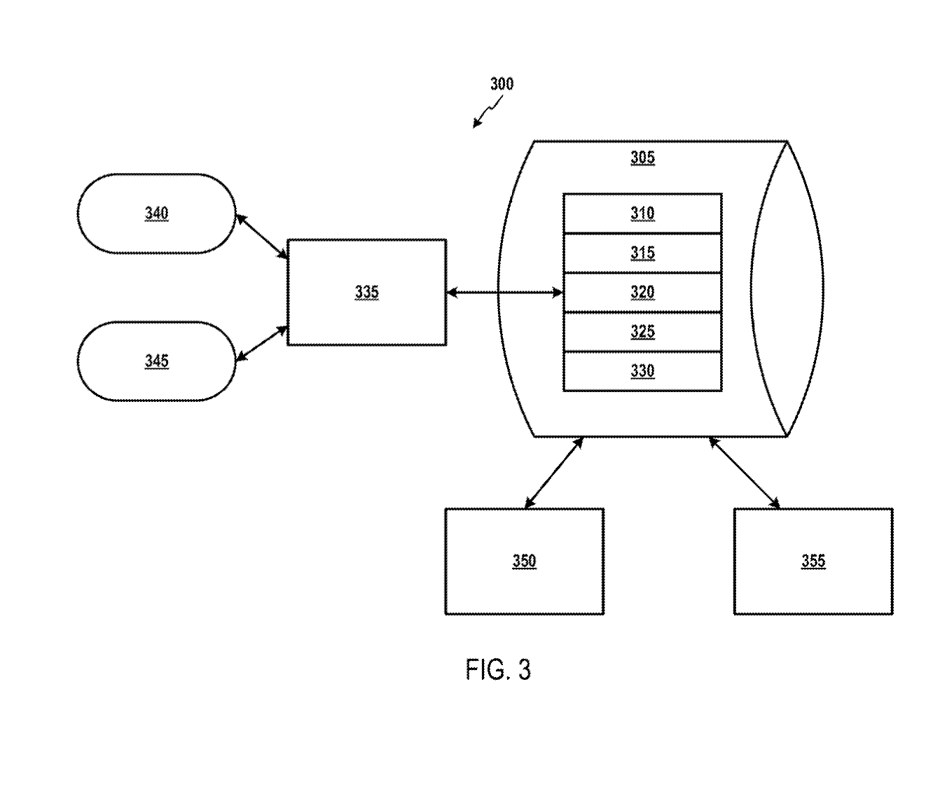

FIG. 3 depicts an illustrative legislative promotion platform management system (“legislative management system”) according to an embodiment. In some embodiments, the legislative management system may be configured to focus on legislative or legal context of preliminary offers, such as laws, regulations, and rules (“regulations”) that may affect the distribution and/or redemption of preliminary offers. As shown in FIG. 3, the legislative management system 300 may include a legislative promotion technology platform (LPTP) 305 configured to analyze preliminary offers and to generate context-based offers and/or to filter the distribution of offers based on regulations associated with the preliminary offers. The LPTP 305 may include and/or have access to information associated with regulations 310, promotions (for example, preliminary offers) 315, CPGs 320, retailers 325, and/or consumers 330. In some embodiments, the LPTP 305 may be configured to provide reporting 350 and/or analytics 355 associated with the promotions 315. CPGs 340 and/or retailers 345 may interface with the LPTP 305 and context-based offers associated therewith through a promotion administration component 335. In some embodiments, the promotion administration component 335 may be configured to manage the distribution and/or redemption of context-based offers generated by the LPTP 305.

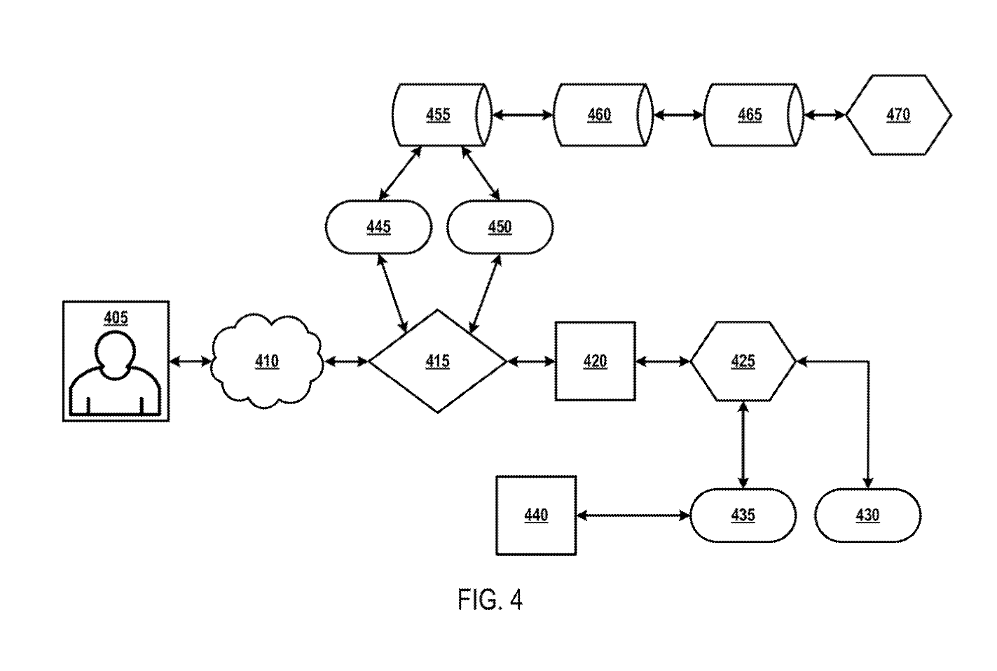

FIG. 4 depicts a flow for an illustrative method for managing consumer interaction with a context-based offer according to an embodiment. As shown in FIG. 4, a consumer 405 may access a promotion 410 involving a regulated product, such as a digital promotion via the Internet or a mobile application accessed using a computing device. The consumer 405 may decide 415 to receive the offer electronically 445 or via mail 450. The selection of the offer and the form thereof may be communicated to an offer management database 455. The information in the offer management database 455 may be accessed by an entity associated with the offer, such as a CPG customer database 460 that may provide the information to a related marketing database 465. The entity, such as the CPG, may use the information to determine and/or develop customer relationships 470. The offer may be transmitted to a clearing house 420 to analyze the consumer decision 415 to receive the offer in view of the context thereof. If the offer is approved 425, the offer may be sent to the user via mail 430 and/or through a digital coupon platform 435 and, for example, loaded onto a retailer loyalty card 440.

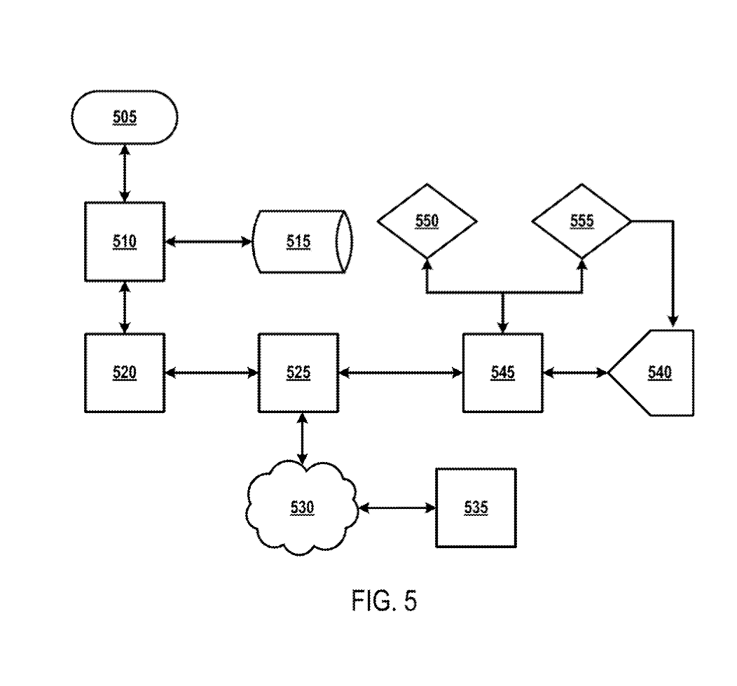

FIG. 5 depicts a flow diagram of an illustrative method of providing a context-based offer using a retailer loyalty card system according to an embodiment. As shown in FIG. 5, a CPG may transmit a promotion offer 505 to an offer management system 510, such as an LPTP. The LPTP 510 may perform a query 515 of a legislative database for legislative conditions for receiving and/or redeeming the promotion offer 505. The LPTP 510 may transmit the offer 505 as a context-based offer based on the results of the legislative database query 515 to a loyalty card system 520. The loyalty card system 520 may load the context-based offer into a retailer loyalty card program 525. The retailer may make the context-based offer available through a promotional delivery system 530, such as paper-based delivery, email, a web-based platform, a mobile application, or the like, to a customer 535. At the POS 545 involving the context-based offer, the retailer system may determine whether the context-based offer may not be redeemed 550 or may be redeemed 555 based on the context. If the context-based offer may be redeemed 555, redemption 540 of the context-based offer may occur at the POS 545 at the retailer.

FIG. 6 depicts a block diagram of exemplary internal hardware that may be used to contain or implement the various computer processes and systems as discussed above. A bus 600 serves as the main information highway interconnecting the other illustrated components of the hardware. CPU 605 is the central processing unit of the system, performing calculations and logic operations required to execute a program. CPU 605, alone or in conjunction with one or more of the other elements disclosed in FIG. 6, is an exemplary processing device, computing device or processor as such terms are used within this disclosure. Read only memory (ROM) 630 and random access memory (RAM) 635 constitute exemplary memory devices.

A controller 620 interfaces with one or more optional memory devices 625 to the system bus 600. These memory devices 625 may include, for example, an external or internal DVD drive, a CD ROM drive, a hard drive, flash memory, a USB drive or the like. As indicated previously, these various drives and controllers are optional devices. Additionally, the memory devices 525 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any of the functional steps associated with managing and incentivizing data entry as described above may be stored in the ROM 630 and/or the RAM 635. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 630 may permit information from the bus 600 to be displayed on the display 635 in audio, visual, graphic or alphanumeric format. Communication with external devices may occur using various communication ports 640. An exemplary communication port 640 may be attached to a communications network, such as the Internet or a local area network.

The hardware may also include an interface 645 which allows for receipt of data from input devices such as a keyboard 650 or other input device 655 such as a mouse, a joystick, a touch screen, a remote control, a pointing device, a video input device and/or an audio input device.

### EXAMPLE

### Brewing Company Promotional Offer

A brewing company generates preliminary offers pertaining to two nationwide offers for a beer product. The context-based offer management system (the “management system”) receives the offers and automatically analyzes the offers to determine the offer types and regulations for delivering the offers in certain jurisdictions.

A first offer is for $1.00 off a single beer product that is less than or equal to 5% alcohol by volume. The management system analyzes the first offer using a legislative database and determines that the first offer can be redeemed in Alaska, Arizona, Colorado, the District of Columbia, Delaware, Iowa, Illinois, Mississippi, Montana, New Hampshire, New Mexico, Oklahoma, South Carolina, Vermont, Wisconsin, and Wyoming. The management system also determines that the offer can be redeemed in California as long as a minimum purchase requirement is met. Furthermore, the management system determines that the offer can be distributed only in three of the Hawaiian Islands (for instance, Hawaii, Honolulu, and Maui).

The second offer is for $1.00 off a single beer product that is less than or equal to 5% alcohol by volume with the purchase of a non-alcohol product. The management system analyzes the first offer using a legislative database and determines that the second offer can be redeemed by consumers in the same states as the first offer, but also in Nebraska and Tennessee.

The management system communicates a context-based first offer and a context-based second offer as filtered offer data to one or more offer distributors. The filtered offer data indicates the regulations that apply to the distribution and/or redemption of the associated offers to the offer distributor. The offer distributor distributes the offers according to the regulations as indicated by the filtered offer data via multiple distribution mechanisms, including a mobile application, a web-based platform, and paper-based distribution.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to”). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example), the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, or the like. As a non-limiting example, each range discussed herein can be readily broken down into a lower third, a middle third, and an upper third. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A system for generating context-based offers, the system comprising:
a processor; and
a non-transitory, computer-readable storage medium in operable communication with the processor, wherein the computer-readable storage medium contains one or more programming instructions that, when executed, cause the processor to:
receive a preliminary offer associated with at least one product,
access context information associated with the at least one product,
determine at least one context for the preliminary offer based on the context information, and
generate a context-based offer for the at least one product based on the context.

2. The system of claim 1, wherein the context comprises a legal context for redemption of the preliminary offer.

3. The system of claim 2, wherein the legal context comprises jurisdictions where the preliminary offer is not valid.

4. The system of claim 1, wherein the product is a regulated product.

5. The system of claim 4, wherein the regulated product comprises at least one of an alcoholic beverage, a nicotine-containing product, and a medical product.

6. The system of claim 1, further comprising one or more programming instructions that, when executed, cause the processor to receive information associated with an attempted redemption of the context-based offer.

7. The system of claim 6, further comprising one or more programming instructions that, when executed, cause the processor to approve the redemption based on characteristics of the attempted redemption corresponding with the context.

8. The system of claim 1, further comprising one or more programming instructions that, when executed, cause the processor to distribute the context-based offer.

9. The system of claim 8, wherein the context-based offer is distributed to at least one of an offer distributor, a retailer, and a consumer.

10. A computer-implemented method for generating context-based offers, the method comprising, by a processor:
receiving a preliminary offer associated with at least one product;
accessing context information associated with the at least one product;
determining at least one context for the preliminary offer based on the context information; and
generating a context-based offer for the at least one product based on the context.

11. The method of claim 10, wherein the context comprises a legal context for redemption of the preliminary offer.

12. The method of claim 11, wherein the legal context comprises jurisdictions where the preliminary offer is not valid.

13. The method of claim 10, wherein the product is a regulated product.

14. The method of claim 13, wherein the regulated product comprises at least one of an alcoholic beverage, a nicotine-containing product, and a medical product.

15. The method of claim 10, further comprising, by the processor, receiving information associated with an attempted redemption of the context-based offer.

16. The method of claim 15, further comprising, by the processor, approving the redemption based on characteristics of the attempted redemption corresponding with the context.

17. The method of claim 1, further comprising, by the processor, distributing the context-based offer.

18. The method of claim 15, wherein the context-based offer is distributed to at least one of an offer distributor, a retailer, and a consumer.

19. A computer-readable storage medium having computer-readable program code configured to generate a context-based offer embodied therewith, the computer-readable program code comprising:
computer-readable program code configured to receive a preliminary offer associated with at least one product;
computer-readable program code configured to access context information associated with the at least one product;
computer-readable program code configured to determine at least one context for the preliminary offer based on the context information; and
computer-readable program code configured to generate a context-based offer for the at least one product based on the context.

20. The computer-readable storage medium of claim 19, wherein the context comprises a legal context for redemption of the preliminary offer.
